(19) United States
(12) Patent Application Publication
(10) Pub. No.: US 2002/0052768 A1
(43) Pub. Date: May 2, 2002

(54) Life events management

(76) Inventors: Martin James Walker, Leighton Buzzard (GB); Adrian Stock, Farnham (GB); Ray Giles, Guildford (GB); Christopher Wood, Huntingdon (GB); Christopher Geary, Hungerford (GB); Robert Kitchen, Colden Common Winchester (GB); Christopher Corcoran, Brightwell Baldwin Watlington (GB); Dag Tungvaag, Stavern (NO)

Correspondence Address: LADAS & PARRY, Suite 2100, 5670 Wilshire Boulevard, Los Angeles, CA, 90036-5679, US

(21) Appl. No.: 09/887,510

(22) Filed: Jun. 22, 2001

(30) Foreign Application Priority Data
Jun. 26, 2000 (GB) 0015474.0

(51) Int. Cl. G06F 17/60

(52) U.S. Cl. 705/7

(57) ABSTRACT

A life-events service provides data-processing resources (25) for executing and managing business and personal life events of the user concerned in an integrated manner. In the preferred embodiments, the service is provided by the enterprise that employs the user and the data processing resources (47) monitor the state of life events executed and/or managed through the service in order to detect and correct any inconsistencies or effect required updates in relation to other enterprise data resources. The service may make available event-related service packages, including for personal life events, through prior agreement with selected service providers (62). For at least certain events (49) the service preferably provides a respective associated know-how map (54) that plots out the tasks (55) required to be fulfilled in relation to the event, the user then being given the opportunity to select (58) a service provider for each task represented in the know-how map.

### FIELD OF THE INVENTION

The present invention relates to the integrated management of business and personal life events where the events concerned can range from simple tasks such as arranging a business trip to complex life episodes such as getting married.

### BACKGROUND OF THE INVENTION

Within large enterprises more and more human resource functions are being moved to a web-based employee self-service footing both to reduce HR costs and to give the employee greater control in areas where employee choice is possible.

The employee may also have access to enterprise applications enabling them to make travel arrangements and purchase from external suppliers.

There are also a myriad of internet sites offering services in respect of an individual's personal life, for example, sites that offer help and advice on house purchase. However, accessing such sites using IT resources of the individual's employer is generally not permitted or permitted only to a minimum degree.

It is an object of the invention to provide a service that facilitates management of life events whether of a business nature or a personal nature and thereby offers advantages not only to individuals but also to enterprises.

### SUMMARY OF THE INVENTION

According to one aspect of the present invention, there is provided a method of operating an enterprise in which the enterprise provides data-processing resources to at least selected employees for executing and managing business and personal life events of the employee concerned in an integrated manner. In the preferred embodiments, the data processing resources monitor the state of life events executed and/or managed through the resources in order to detect and correct any inconsistencies or effect required updates in relation to other enterprise data resources whereby enterprise data about the employee is kept in step with changes in employee personal data occasioned by personal life events of the employee.

Advantageously, the enterprise makes available event-related service packages through prior agreement with selected service providers, at least certain of these service packages relating to tasks involved in personal life events.

Preferably, for at least certain events the data processing resources provide a respective associated know-how map that plots out the tasks required to be fulfilled in relation to the event, the data processing resources giving the employee the opportunity to select a service provider for each task represented in the know-how map and enabling task-execution interactions to take place between the employee and the service provider selected by the employee.

The provision of such a service by an enterprise to its employees provides substantial benefits to the enterprise in terms of employee satisfaction, employee retention, employee efficiency, and reduced internal human resource overhead.

According to another aspect of the present invention, there is provided a life-events management service involving providing data-processing resources for executing and managing business and personal life events of a user in an integrated manner with the state of life events executed and/or managed through the service being monitored in order to detect and correct any inconsistencies or effect required updates across events.

According to a further aspect of the present invention, there is provided life-events management service involving providing data-processing resources for executing and managing business and personal life events of a user in an integrated manner, the service making available event-related service packages through prior agreement with selected service providers.

According to a still further aspect of the present invention, there is provided a life-events management service involving providing data-processing resources for executing and managing business and personal life events of a user in an integrated manner, the data processing resources providing, for at least certain events, a respective associated know-how map that shows the tasks required to be fulfilled in relation to the event, the data processing resources giving the user the opportunity to select a service provider for each task represented in the know-how map and enabling task-execution interactions to take place between the user and the service provider selected by the user.

The present invention also encompasses data processing resources for implementing the above methods and services.

### BRIEF DESCRIPTION OF THE DRAWINGS

A life-events management service embodying the invention will now be described, by way of non-limiting example, with reference to the accompanying diagrammatic drawings, in which:

FIG. 1 is a diagram showing the conceptual inter-relationship of the main elements of the present embodiment of the invention;

FIG. 2 is a diagram of the processing environment in which the service is provided;

FIG. 3 is a diagram of the life-events management program that provides the present implementation of the life-events management service embodying the invention;

FIG. 4 shows a user screen display during the service-provider selection stage of the survey task of a house-purchase life event; and

FIG. 5 shows a user screen display during an organize-business-trip life event.

### BEST MODE OF CARRYING OUT THE INVENTION

Much of what an individual does in life can be considered as being a sequence of events where the events can range from simple events such as shipping goods from A to B, to complex events (life “episodes”), such as getting married, that involve multiple related tasks. It is common to compartmentalise one's life into events happening in the business context and events happening in one's personal life; indeed, individuals often further divide up their personal life by splitting out events concerned with their family, their place of habitation, their health, etc.

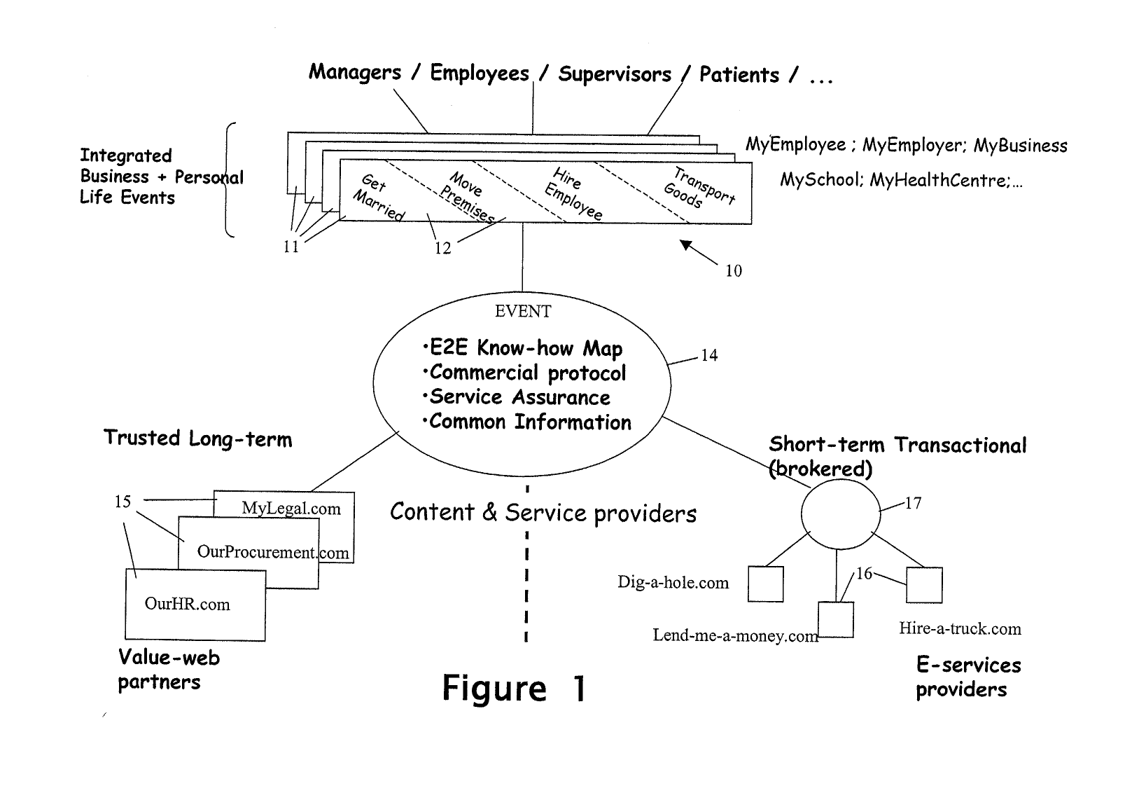

FIG. 1 expresses this division in terms of a set 10 of life-event “planes” 11 where each plane relates to events 12 concerned with a particular aspect of an individuals life such as business (working) world, house, family, personal (in the narrow sense), etc. In accordance with the present embodiment of the invention, an employee of an enterprise is provided with a service available through the data processing resources of the enterprise, for executing and managing events in all the planes 11 of the set 10.

For each identified event included in one of the planes 11, the employee is offered a general set of resources 14 the main components of which are:

a know-how map depicting the tasks that must be performed to execute the event;

information about possible service providers in respect of the required tasks, these service providers including:

service providers 15 (here called “value-web partners”) that by prior agreement with the enterprise (or their agent) have undertaken to provide service packages to the employees of the enterprise of a certain quality- this may be in respect of one or both of business events and personal events;

service providers 16 chosen by the individual from amongst those found using a service brokerage 17;

appropriate communication protocols for contacting the service providers;

general information about the tasks to be performed for the event.

The employee carries out an event by following the know-how map and selecting between the offered service providers, the subsequent interaction between the employee and service provider being accommodated by the IT resources of the enterprise.

The execution and management of events is effected in an integrated manner so as to ensure consistency of data between events and to avoid scheduling clashes. Also, provision is made to ensure that the personal data of the employee that is used by other enterprise applications, is kept up-to-date with any changes brought about as a result of events executed through the life-event management service.

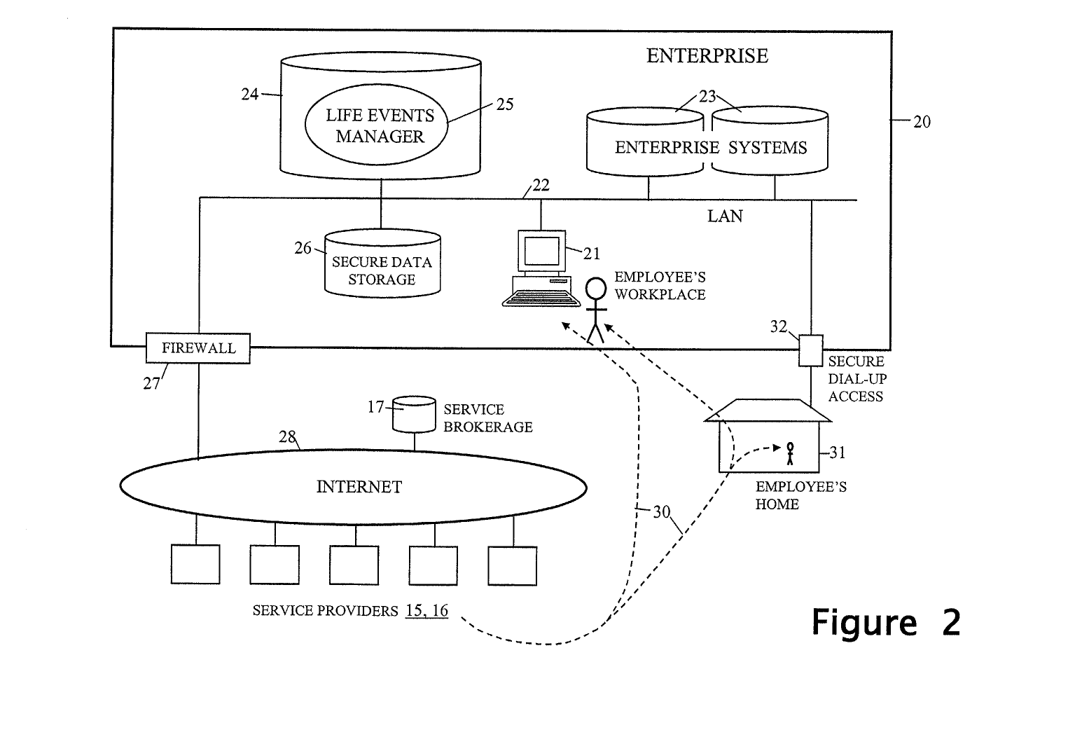

FIG. 2 shows the general IT environment in which the present embodiment of the invention is implemented. An employee of enterprise 20 has a workplace 21 with a PC connected to the enterprise LAN 22. Also connected to LAN 22 are a number of enterprise systems 23 (generally servers) providing accounting, personnel, and other applications. A further server 24 runs the life-events management service program 25. A secure data storage server 26 (here shown separate to server 24 but potentially instantiated on the same machine) provides for secure storage of personal data of each employee using the life-events management program—each employee has their own data area that stores their personal data in encrypted form such that it is only accessible to them and not even to the IT staff of the enterprise. Similar security measures are undertaken to ensure that the employees personal data is also only accessible to them whilst being used as part of the provision of service by the life-events management program. Appropriate security techniques are known to persons skilled in the art. Of course, some elements of daa about an employee are legitimate for the enterprise to know and these elements are specified to the life-events management system so that the latter can notify the enterprise systems in any changes to such elements. The list of such elements can only be changed with the approval of the employee concerned (though acceptance of an initial list is a pre-condition for use by an employee of the life-event management service).

The LAN 22 provides access to the internet 28 through firewall 27. This permits the life-events management program 25 to establish contact with service providers 15, 16 and service brokerage 17 which are also connected to the internet 28. The service providers can then provide event-related services to the employee under the supervision of the life-events management program; since one role of the program 25 is to detect changes brought about by service provision that need to be reported to other event services and to the enterprise systems 23, all contact between the service providers 15, 16 and employees is preferably done through the server 24.

The employee can also access the server 24 and thus the life-events management program 25 via a secure dial-up connection 32 from the employee's home 31. Similarly, the employee can access the service providers 15, 16 via the employee's own IAP (Internet Access Provider) 34 from home; for security reasons this would involve the employee being passed an appropriate secret password whilst connected at work that the employee can use to connect to the service provider from home to continue the service provision in respect of a particular event. In order to enable the program 25 to continue to perform its role of ensuring consistency between events and with the system enterprises, where an employee directly connects to the service provider, either the service provider or the employee is required to use software that reports relevant changes to the program 25.

Of course, service provision may also involve communications 30 through non-electronic media (such as the mail system) to the employee either at work or at home. The employee will then need to enter event-relevant data contained in the non-electronic communication so that the program 25 can be made aware of this data.

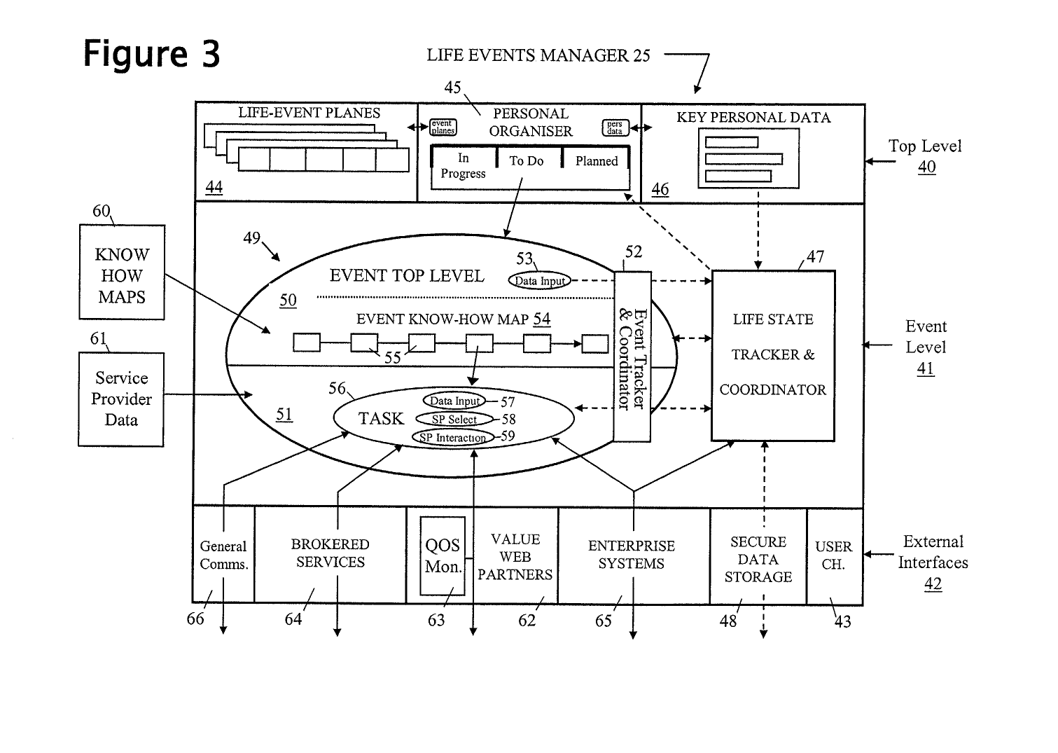

Having described the general environment in which the life-events management program operates, a more detailed description of the functionality of the program will now be given with reference to FIG. 3.

In FIG. 3 the program 25 is represented by a functional block diagram and is shown as having three main levels, namely a top level 40 concerned with top-level interface with the employee (for convenience, the term “user” will be utilised from now on); an event level 41 concerned with the execution and management of specific events; and an interface level 42 for providing appropriate interfaces to communicate the program 25 with a variety of services and systems. The user communicates with the program 25 through use channel 43 of the interface level 42, this channel being responsible for logging the user on and off. The top level 40 of program 25 offers the user a personal-organiser overview 45 of life events in progress, to be done (i.e. required to be done), and planned (but not immediately required). From this view 45, the user can choose a new event to be done/planned by going to the life-event planes view 44 that shows a representation of the set of planes depicted in FIG. 1—in this view 44, the user can select a plane and then choose the desired life event, transferring it to the appropriate part of the organiser view 45. Also from the organiser view, the user can choose to see a diary of scheduled activities or can choose to go to a personal details input/edit screen 46 to input/update generic personal details. New or changed details are handled by a life state tracker and coordinator functional block 47 that manages the personal and state data relevant to the user and their current events; the coordinator block 47 is responsible for retrieving/saving this data from/to secure storage 26 via interface 48. The coordinator block 47 is also responsible for ensuring data and scheduling integrity both between the user's events and between the program 25 and the enterprise systems 23.

To work on an event, the user selects the event from the personal organiser view 45 which starts an event program 49 of the same generic form for each event but with event specific customisations. The event program 49 provides a top level interface 50 for the event including a data input function 53 for inputting/updating data generic to the event, and the know-how map 54 relevant to the event (retrieved from a store 60 of know-how maps). For simple events which are effectively constituted by one task, a know-how map may not be provided. Where a know-how map is provided, it shows the tasks 55 required to be effected to execute the event and also indicates the progress to date (if any) in executing each task (for example, by a color coding scheme or % dial display).

The input of event-specific data is managed by an event-tracker and coordination functional block 52 which has the following roles:

to keep track of the progress through the event,

to ensure data and scheduling consistency between the constituent tasks of the event, and

to act as an interface with the main coordinator block 47 by passing the latter new/updated data for the block 47 to store and do consistency checking with other events and with the enterprise systems 23.

Assuming the user wishes to start work on a particular task 55, the user selects the task 55 from the know-how map to start the relevant task program 56. A task program typically comprises two initial stages (namely, data input 57 for the input of initial task-specific data by the user, and service provider selection 58), and a main stage of interaction between the user and service provider during which the task is actually executed. The details of the interaction stage will generally be task and service provider specific and will not be considered here.

Task relevant data (including state and personal data) is passed to the event coordinator block 52 and, as appropriate, to the main coordinator block 47 to enable these blocks to carry out their data and scheduling consistency checks. The task program 56 may also include explicit updating of the enterprise systems 23.

With regard to the selection of a service provider to carry out a task, the user will normally be presented with a list of “value-web partners” which have been previously lined up by the enterprise (or their agents) for the provision of services of a particular quality. Data about these service providers is held in store 61. If such a provider is selected, then the user initiates interaction with the selected provider through an interface 63 that includes a Quality of Service tracking block 63; this block monitors the quality of service provided by the service provider both by tracking the messages exchanged and by accessing the task state data held by coordinator block 52. In this way, the enterprise (or its agents) can ascertain whether its value-web partners are proving adequate service levels.

If the user opts not to use a value-web partner, or if no such partner is available/designated for a particular task, then the user is enabled to contact a brokerage service such as service 17 via an appropriate interface 64 (for example, one conditioned to use the “e-speak” technology of Applicant). Once a service provider has been chosen via the brokerage, communication with the selected service provider may be continued by any appropriate communications means (web interface, e-mail, etc as represented by the general communications interface 66 in FIG. 3).

As already noted, the coordination blocks 47 and 52 play an important role in ensuring data and scheduling integrity, the block 52 effecting this role within an event and the block doing so at the inter-event level and with respect to the enterprise systems. By scheduling integrity is meant that the user does not arrange to be in two places at once or do two incompatible activities at the same time. Scheduling integrity checking can be provided for simply by using a detailed diary (this being the same diary as visible to the user from the personal organiser 45). This data and scheduling integrity checking is effected across all events whether personal or business. The blocks 47 and 52 are also responsible for holding state data respectively on the overall program 45 (including what events are current for a user) and on each individual event.

It will be appreciated that the functionality of the program is instantiated for each user currently signed on and that the data of each user (both event state data and personal data) user is handled separately. It will also be appreciated that the event and task programs have access to the user's personal data but the export of that data to external service providers is only done with the explicit consent of the user.

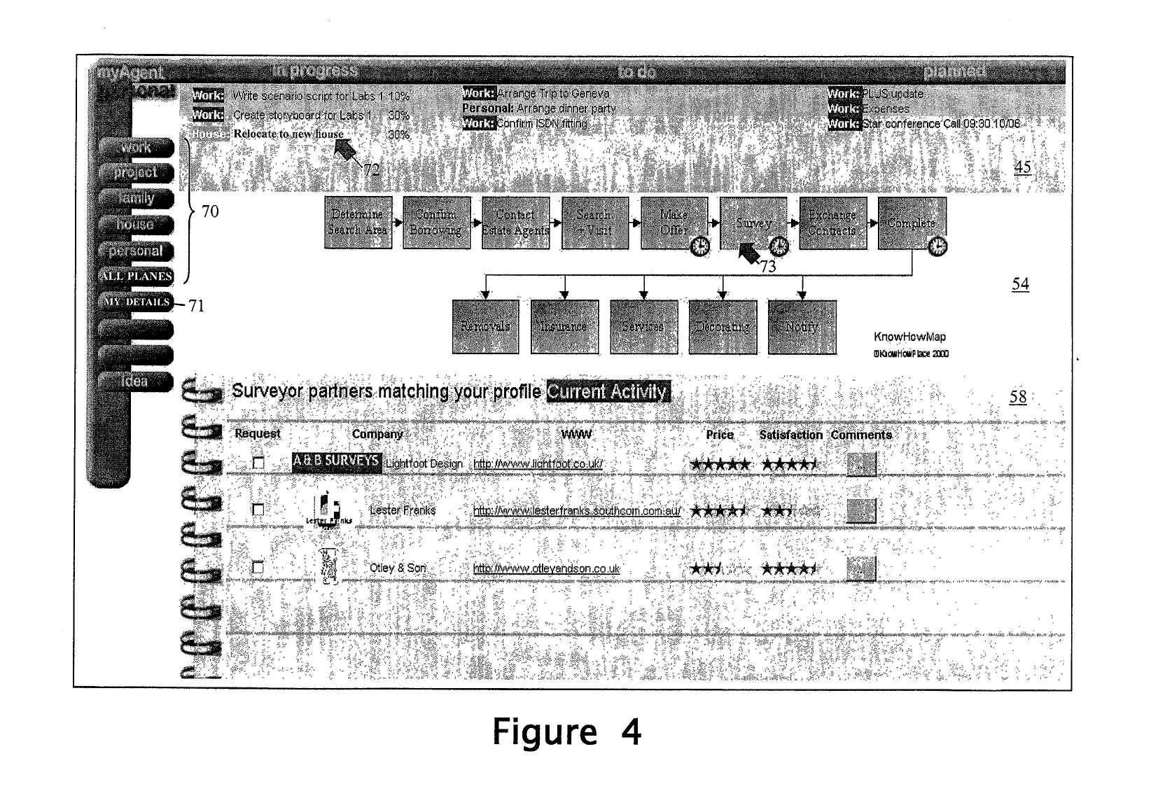

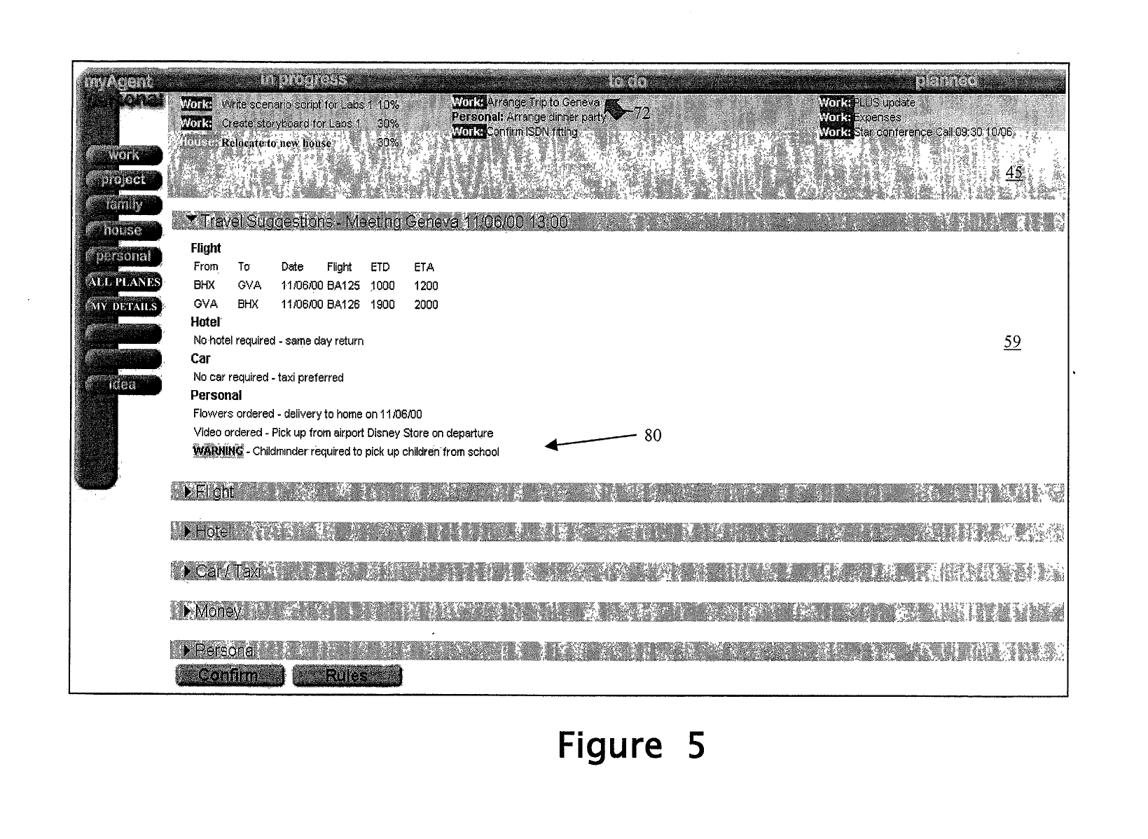

FIGS. 4 and 5 show example screens visible during program execution. More particularly, FIG. 4 shows a screen displayed during selection of a service provider to carry out a survey task that is part of a house purchase event. At the top of the FIG. 4 screen is displayed the organiser view 45 with “In Progress”, “To do” and “Planned” events listed, the events being color-coded according to which life-event plane they belong. Arrow 72 indicates that the “relocate to new House” event has been selected as a result of which the know-how map 54 for house purchase is displayed showing the set of tasks associated with house purchase and the progress to date through these tasks. In the present case, the use needs to initiate the Survey task and has selected the task as indicated by arrow 73. Since the task has not been previously commenced, the user is being asked to select a surveyor from a set of three surveyors in the value-partner web (see 58).

The buttons 70 on the right of the screen enable the user to jump to the life-planes (all or individually) in order to choose a new event. Button 71 enables the user to choose to add/update their details.

The FIG. 5 screen relates to the task of making arrangements for a business trip. The screen displays the organiser 45 and arrow 72 shows that the “Arrange trip to Geneva” event has been selected. Although arranging a business trip involves arranging a number of different things (flight, travel to/from airport, etc), in the present embodiment this event is treated as a single task. One reason for this is that travel booking applications are already fairly sophisticated and it is therefore unnecessary to break down the event into several tasks. (It may be noted that this contrasts with making arrangements for a family trip abroad which is likely to be divided into multiple tasks since account needs to be taken of matters such as ensuring that all the family have current passports, the family pets are taken care of, etc.). In the present example, the user has either already made a selection of service provider or this step has been skipped because the enterprise has a fixed policy about which service provider has to be user. The FIG. 5 screen thus shows the initial stage of task execution (see 59) in which the user is being presented with a suggested solution. Of note is the displayed warning 80 concerning the need to make arrangements for a child minder to pick up the user's children from school. This warning is generated as a result of the coordinator 47 having detected a schedule conflict with the user's recurring diaried event of picking up the children at a specific time during school terms. The coordinator has been previously taught by the user that such a schedule conflict is to be solved by use of child minder. As well as initiating the warning 80, the coordinator 47 can also be arranged to create a new event in the “To Do” column for arranging a child minder.

With respect to the recurring event of picking up the children, the diary component of the program 25 can advantageously be provided with a facility for readily scheduling recurring activities; indeed, the diary can conveniently be used to schedule any activity that does not require executing a related task (and so would not find its way into the diary by virtue of being associated with an event).

Many variations are, of course, possible to the above described embodiment of the invention. For example, provision can be made for the user to choose the events included in the life event planes and, indeed, for the use to choose what planes to have. Thus a manager will want to have certain supervising-related events (e.g. doing performance evaluations) on their business plane whilst a married family person with children would want to remove the marriage event but include events relating to children's education. Of course, the program 25 can be arranged to effect event selection based on the user's input personal data. The program can also be arranged to schedule recurring events into the organiser and diary.

Whilst the life events management service has been described in the context of being made available by an enterprise to at least selected employees, the service could be provided independently over the internet to individuals. Enterprises could still benefit by arranging for updates to an employees details to be passed from the service to the enterprise's own IT systems (this would need to be with the consent of the employee and would require appropriate authentication of the life-events management service provider to the enterprise).

1. A method of operating an enterprise in which the enterprise provides data-processing resources to at least selected employees for executing and managing business and personal life events of the employee concerned in an integrated manner.

2. A method according to claim 1, wherein the enterprise provides secure storage space for electronically holding personal data on behalf of the employee in a manner such that the enterprise is not able to access that data.

3. A method according to claim 1, wherein the data processing resources monitor the state of life events executed and/or managed through them, in order to detect and correct any inconsistencies or effect required updates in relation to other enterprise data resources whereby enterprise data about the employee is kept in step with changes in employee personal data occasioned by personal life events of the employee.

4. A method according to claim 1, wherein the data processing resources monitor the state of life events executed and/or managed through them, in order to detect and correct any inconsistencies or effect required updates across events.

5. A method according to claim 1, wherein the enterprise makes available event-related service packages through prior agreement with selected service providers, at least certain of these service packages relating to tasks involved in personal life events.

6. A method according to claim 5, wherein at least for certain events, the employee has the option of selecting between services provided by a said selected service provider and services discovered through a brokerage service.

7. A method according to claim 5, wherein the quality of service provided by a selected service provider when providing service to an employee through a service package is monitored by the enterprise.

8. A method according to claim 1, wherein for at least certain events the data processing resources provide a respective associated know-how map that plots out the tasks required to be fulfilled in relation to the event, the data processing resources giving the employee the opportunity to select a service provider for each task represented in the know-how map and enabling task-execution interactions to take place between the employee and the service provider selected by the employee.

9. A method according to claim 8, wherein for multi-task events the resources further provide both consistency checking between tasks and status tracking for the event as a whole.

10. A life-events management service involving providing data-processing resources for executing and managing business and personal life events of a user in an integrated manner with the state of life events executed and/or managed through the service being monitored in order to detect and correct any inconsistencies or effect required updates across events.

11. A life-events management service according to claim 10, wherein the service inter-works with other data processing resources associated with the business life of the user in order to detect and correct any inconsistencies or effect required updates in relation to those other data resources.

12. A life-events management service according to claim 10, wherein the service makes available event-related service packages through prior agreement with selected service providers.

13. A life-events management service according to claim 12, wherein at least for certain events, the user has the option of selecting between services provided by a said selected service provider and services discovered through a brokerage service.

14. A life-events management service according to claim 12, wherein the quality of service provided by a selected service provider when providing service to a said user through a service package is monitored by the life-events management service.

15. A life-events management service according to claim 10, wherein for at least certain events the data processing resources provide a respective associated know-how map that plots out the tasks required to be fulfilled in relation to the event, the data processing resources giving the user the opportunity to select a service provider for each task represented in the know-how map and enabling task-execution interactions to take place between the employee and the service provider selected by the user.

16. A life-events management service according to claim 15, wherein for multi-task events the resources further provide both consistency checking between tasks and status tracking for the event as a whole.

17. A life-events management service involving providing data-processing resources for executing and managing business and personal life events of a user in an integrated manner, the service making available event-related service packages through prior agreement with selected service providers.

18. A life-events management service according to claim 17, wherein at least for certain events, the user has the option of selecting between services provided by a said selected service provider and services discovered through a brokerage service.

19. A life-events management service according to claim 17, wherein the quality of service provided by a selected service provider when providing service to a said user through a service package is monitored by the life-events management service.

20. A life-events management service according to claim 17, wherein for at least certain events the data processing resources provide a respective associated know-how map that plots out the tasks required to be fulfilled in relation to the event, the data processing resources giving the user the opportunity to select a service provider for each task represented in the know-how map and enabling task-execution interactions to take place between the user and the service provider selected by the user.

21. A life-events management service according to claim 20, wherein for multi-task events the resources further provide both consistency checking between tasks and status tracking for the event as a whole.

22. A life-events management service involving providing data-processing resources for executing and managing business and personal life events of a user in an integrated manner, the data processing resources providing, for at least certain events, a respective associated know-how map that shows out the tasks required to be fulfilled in relation to the event, the data processing resources giving the user the opportunity to select a service provider for each task represented in the know-how map and enabling task-execution interactions to take place between the user and the service provider selected by the user.

23. A life-events management service according to claim 22, wherein for multi-task events the resources further provide both consistency checking between tasks and status tracking for the event as a whole.

24. A life-events management service according to claim 22, wherein the service makes available event-related service packages through prior agreement with selected service providers and the user has the option of selecting such a package for effecting one or more tasks related to a current event or of using a service provider discovered through a brokerage service.

25. A life-events management service according to claim 24, wherein the quality of service provided by a selected service provider when providing service to a said user through a service package is monitored by the life-events management service.
